(19) United States
(12) Patent Application Publication
(10) Pub. No.: US 2007/0094715 A1
(43) Pub. Date: Apr. 26, 2007

(54) Two-factor authentication using a remote control device

(75) Inventors: Darryl J. Brown, Seattle, WA (US); David J. Steeves, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/254,497

(22) Filed: Oct. 20, 2005

(51) Int. Cl. H04L 9/32

(52) U.S. Cl. 726/5

(57) ABSTRACT

Techniques for performing two-factor authentication using a remote control device are provided. A remote control device is equipped with components to allow a user of the remote control device to provide two-factor authentication credentials using the remote control device. The remote control device is capable of obtaining both a physical factor, such as a smart card, etc., and a memorized factor, such as a PIN. The remote control device then transmits signals representing both factors to a receiving device, such as a computer system, thus allowing the receiving device to authenticate the user of the remote control device using the submitted physical and memorized factors.

### BACKGROUND

More and more computer systems require its users to provide credentials, such as a username and password, in order to access and use the computer system. These computer systems typically provide an administrator account that may be initially used to access the computer system and to create one or more user accounts.

When creating a user account for the first time, the computer system may request that the user specify a login identifier, or login ID, and an associated password. Generally, the login ID is unique to the computer system such that no two users have the same login ID. The combination of the login ID and the password that is associated with the login ID allows the computer system to authenticate the user during subsequent accesses of the computer system. The password also prevents others who do not know the password from accessing the computer system using the user's login ID. This password protection is particularly important if the computer system allows its users to store private or confidential information about the user, such as financial information, confidential content, etc.

Increasing numbers of computer systems, such as, by way of example, integrated entertainment systems like MICROSOFT WINDOWS Media Center, are being designed with usability by remote control devices as well as the standard computer input devices, such as a keyboard. It is not uncommon for users to use these systems at various locations where the standard keyboard is not readily accessible to the users. For example, a user may be at a location where the user only has access to the remote control device and not the keyboard. In this instance, users are likely to be controlling the system using only the remote control device and not the keyboard. Thus, when users are prompted to generate their own passwords for the user accounts, they often specify a blank password or, in the event the users provide a password, they specify a password that is both easy to remember and one that they can enter using the number pad on the remote control device. This is because users of these systems want to be able to enter the passwords using only the remote control device without having to use the standard keyboard, which may not be readily accessible. Such passwords may be duplicative of their 4-digit bank PIN, or other combinations of numbers, which are cryptographically weak since the password is limited to a combination of numbers.

### SUMMARY

Techniques for performing two-factor authentication using a remote control device are provided. A remote control device is equipped with components to allow a user of the remote control device to provide two-factor authentication credentials using the remote control device. The remote control device is capable of obtaining both a physical factor, such as a smart card, etc., and a memorized factor, such as a PIN. The remote control device then transmits signals representing both factors to a receiving device, such as a computer system, thus allowing the receiving device to authenticate the user of the remote control device using the submitted physical and memorized factors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates selected components of a remote control device suitable for conducting two-factor authentication, according to some embodiments.

FIG. 2 is an isometric view of an example remote control device suitable for use with a smart card, according to one embodiment.

FIG. 3 is an isometric view of an example remote control device suitable for use with a secure token, according to one embodiment.

FIG. 4 is an isometric view of an example remote control device suitable for use with biometrics, according to one embodiment.

FIG. 5 is a flow diagram that illustrates two-factor authentication using the remote control device, according to some embodiments.

### DETAILED DESCRIPTION

Various techniques for performing two-factor authentication using a remote control device are described. As is known to those skilled in the art, two-factor authentication generally refers to an authentication protocol that requires two forms of authentication to access a system, as compared to the traditional password authentication, which only requires the submission of a valid password to gain access to a system. The first factor in the two-factor authentication is typically a physical token, such as, by way of example and not limitation, a card, a smart card, an electronic badge, a secure token (e.g., random number generator), or a fingerprint or retinal pattern (also referred to as biometrics). The second factor in the two-factor authentication is something that is memorized, such as a security code or a PIN. In this context, the first factor may be referred to as the physical factor, and the second factor may be referred to as the mental or memorized factor. A common example of two-factor authentication is a bank card (e.g., credit card, debit card, etc.) and the corresponding PIN. The card itself is the physical factor, and the PIN is the memorized factor. In some scenarios, the security code or PIN may be set to “blank” (e.g., PIN==NULL).

In some embodiments, a remote control device is equipped with components to allow a user of the remote control device to provide two-factor authentication credentials using the remote control device. The remote control device is capable of obtaining both factors (i.e., the physical factor and the memorized factor) from its user and transmitting signals representing both factors to a receiving device, such as a computer system. By way of example, one or more smart cards for use with a remote control device may be provided with a computer system. A user can then use the provided smart card and the remote control device to create a user account on the computer system. For example, the user can create the user account by accessing a create user account feature provided on the computer system. The user can then insert the smart card into a slot provided on the remote control device and provide a PIN using the remote control device to create the user account. In the instance where the physical factor is a biometric factor, the remote control device provides a component that is capable of reading the biometric characteristic of the user. Subsequently, the user may detect a need to perform two-factor authentication on the computer system (e.g., to access the user account, to access a feature provided by the computer system, etc.). The user can then use the remote control device to transmit a representation of both the physical factor (e.g., the smart card) and the memorized factor (e.g., the PIN) to the computer system in order to perform the two-factor authentication. For example, the representation may be a hash, subset f(x), etc. of both the physical and memorized factors. The computer system receives both factors transmitted by the remote control device and authenticates the user's credentials using both of the received factors.

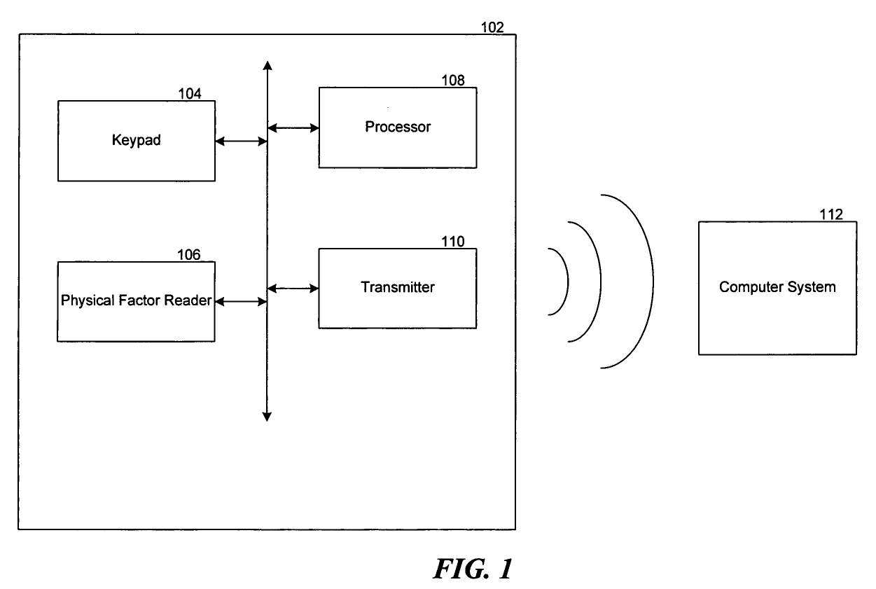

FIG. 1 is a block diagram that illustrates selected components of a remote control device suitable for conducting two-factor authentication, according to some embodiments. As depicted, a remote control device 102 comprises a keypad 104, physical factor reader 106, a processor 108, and a transmitter 110. The keypad facilitates the inputting of control commands for processing by the remote control device. For example, a user can use the keypad to enter commands to be processed and transmitted by the remote control device. The physical factor reader facilitates the reading and processing of a physical factor provided by, for example, the user of the remote control device. Examples of physical factor readers include, without limitation, a smart card reader that is capable of reading information that is provided on the smart card; a card reader that is capable of reading information that is provided, for example, on a magnetic strip on the back of the card; and a biometric scanner, such as a fingerprint scanner, a retina scanner, or a voice frequency scanner. In the instance where the physical factor reader is a biometric scanner, the biometric scanner takes an image of the biometric characteristic (e.g., fingerprint, retina, etc.) and may convert the image into a digital representation for processing. Smart card readers and card readers are similarly read the information provided on the card and may convert the information into a digital representation for processing. Smart card readers, card readers, and biometric scanners suitable for integration into the remote control device as disclosed herein are generally known to one of ordinary skill in the art. For example, suitable biometric scanners are available from MICROSOFT CORP., of Redmond, Wash., and Veridicom International Inc., of Seattle, Wash. Likewise, suitable card readers and smart card readers are readily available.

In general terms, the processor controls the operation of the components of the remote control device. For example, the processor may executes program instructions stored in memory (not shown) thereby providing the remote control device its functionality, such as processing the input received via the keypad and/or the physical factor reader for transmission by the transmitter. The transmitter transmits signals that represent the input provided via the keypad and/or the physical factor reader for reception by a receiving device, such as a computer system 112. In some embodiments, the transmitter is a Bluetooth-compliant transmitter. In other embodiments, the transmitter may support connectivity and communications via any of a variety of well-known wireless protocols, such as infrared (IR), or wired protocols. For example, assuming that the remote control device is a smart phone with a remote control application, the communication protocol may be TCP/IP.

The aforementioned components of the remote control device are only illustrative and are not intended to suggest any limitation as to the implementation of the illustrated components and/or the scope of use or functionality of the remote control device. For example, in some embodiments where the physical factor reader is a smart card reader, the smart card reader may encrypt the information provided on the smart card using a cryptographic key that is also provided on the smart card. In some embodiments, the remote control device may not include one or more of the illustrated components, or may include other components or logic in addition to those illustrated above. For example, in embodiments where the remote control device is intended for use with a token (e.g., a random number generator), the remote control device may not include the physical factor reader.

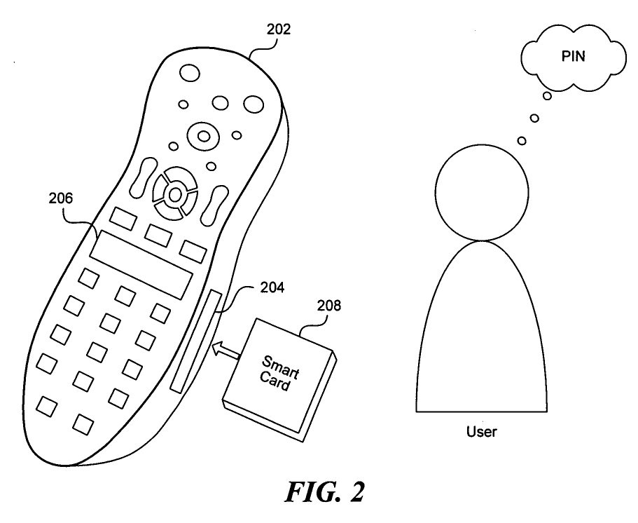

FIG. 2 is an isometric view of an example remote control device suitable for use with a smart card, according to one embodiment. As depicted, remote control device 202 includes a smart card reader 204 and a display screen 206. In order to use the remote control device to logon to a computer system requiring two-factor authentication, the user inserts a smart card 208 into the smart cart reader 204, causing the smart card reader to read the information contained in the smart card. The user then uses the keypad provided on the remote control device to enter a PIN. In one embodiment, the PIN entered by the user may be displayed in plain text on the display screen. In another embodiment, the PIN entered by the user may be displayed in hidden text (e.g., each number displayed as a “*”). This allows the user to determine the accuracy of the user's input (e.g., the PIN or the number of digits or characters inputted) before requesting the remote control device to transmit the user's input. Having provided the smart card and entered the PIN, the user commands the remote control device, for example, by depressing an “enter” or a “send” key on the remote control device, to transmit the information read from the smart card and the user-entered PIN. The transmitted information is then received by the computer system and used to authenticate the user using two-factor authentication. Subsequent to successfully logging onto the computer system, the user can remove the smart card from the smart card reader and continue to use the remote control device without the smart card to control the functions and features provided by the computer system. Thus, the remote control device does not transmit the information read by the smart card reader and the user-entered PIN until the user commands the remote control device to transmit this information. In one embodiment, subsequent to the user removing the smart card from the smart card reader (e.g., after successfully logging onto the computer system), the remote control device may transmit its received input (e.g., the user's input using the remote control device) without requiring the user to separately command the remote control device to transmit.

In another embodiment, the remote control device may not include a display screen. In these embodiments, the user's input (e.g., the PIN or the memorized factor) is not displayed on the remote control device. In still another embodiment, the remote control device may include a card reader that is configured to read information from a magnetic strip affixed toga card.

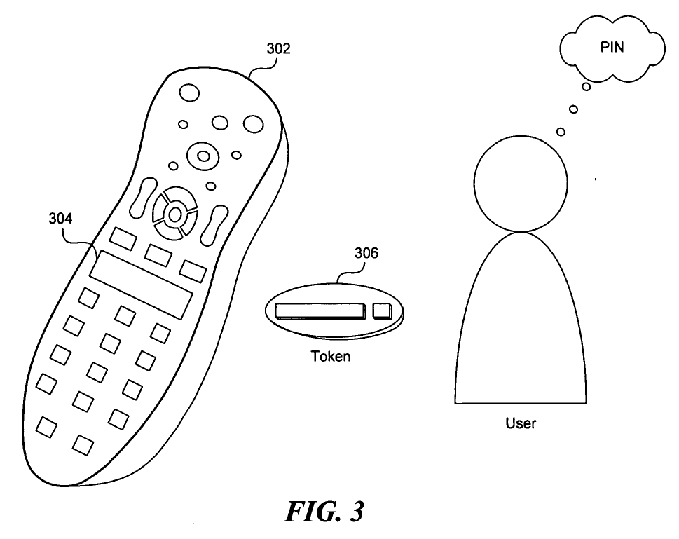

FIG. 3 is an isometric view of an example remote control device suitable for use with a secure token, according to one embodiment. As depicted, remote control device 302 includes a display screen 206. In order to use the remote control device to logon to a computer system requiring two-factor authentication, a user uses the keypad provided on the remote control device to enter a number that is generated by a token 306. The token is a secure, trusted device that randomly generates a number by using a random number generator. The token may randomly generate a new number once every few seconds (e.g., every nine to ten seconds) to once every few minutes (e.g., once every one to two minutes). The token is also “keyed” to the computer system, which allows the computer system to determine at any time the number that is currently being generated by the token. Subsequent to entering the number generated by the token, the user uses the keypad provided on the remote control device to enter a PIN. The user's input may be displayed in plain text or hidden text, or a combination of plain and hidden text (e.g., the number generated by the token is displayed in plain text and the PIN in hidden text), on the display screen. The user can then command the remote control device to transmit the received input (i.e., the number generated by the token and the user-entered PIN). The transmitted information is then received by the computer system and used to authenticate the user using two-factor authentication. Subsequent to successfully logging onto the computer system, the user can continue to use the remote control device without providing the number generated by the token to control the functions and features provided by the computer system.

In another embodiment, the remote control device transmits the number generated by the token and the user's PIN separately. For example, the user uses the keypad to enter a number that is being generated by the token on the remote control device and commands the remote control device to transmit the user's input. Subsequently, the user uses the keypad provided on the remote control device to enter a PIN and commands the remote control device to transmit the user's input.

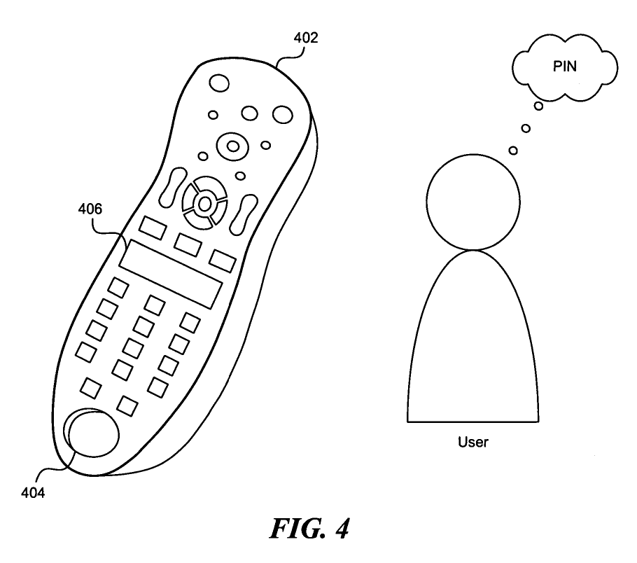

FIG. 4 is an isometric view of an example remote control device suitable for use with biometrics, according to one embodiment. As depicted, remote control device 402 includes a biometric reader 404 and a display screen 406. In order to use the remote control device to logon to a computer system requiring two-factor authentication, the user places the user's biometric characteristic (e.g., finger, retina, etc.) on or substantially near the biometric reader to enable the biometric reader to read the biometric characteristic. For example, in the case where the biometric reader is a fingerprint scanner, the user places the user's finger or thumb on the fingerprint scanner. The fingerprint scanner then scans and creates an image of the fingerprint. The user then uses the keypad provided on the remote control device to enter a PIN. The user's PIN may be displayed in plain text or hidden text on the display screen. Having entered the PIN, the user commands the remote control device to transmit the image of the biometric characteristic and the user-entered PIN. The transmitted information is then received by the computer system and used to authenticate the user using two-factor authentication. Subsequent to successfully logging onto the computer system, the user can continue to use the remote control device without providing the biometric characteristic to control the functions and features provided by the computer system.

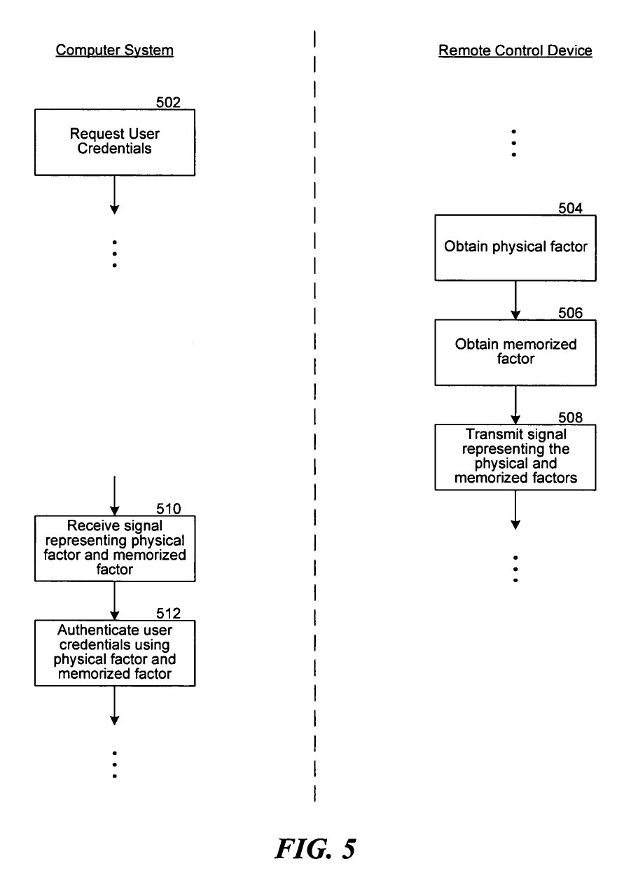

FIG. 5 is a flow diagram that illustrates two-factor authentication using the remote control device, according to some embodiments. At a block 502, a computer system requests user credentials. For example, the computer system may require a user to logon using two-factor authentication. In block 504, the user's remote control device obtains the user's physical factor. In block 506, the user's remote control device obtains the user's memorized factor. In block 508, the user's remote control device transmits a signal representing the user's physical and memorized factors. In block 510, the computer system receives the signal transmitted by the user's remote control device (i.e., the signal representing the user's physical factor and memorized factor). In block 512, the computer system authenticates the user's credentials using the received physical and memorized factor.

One skilled in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps.

In an alternative embodiment, the remote control device is a two-factor authentication-enabled remote control device. In this embodiment, the remote control device includes logic to enable certain functionality provided by the remote control device upon the remote control device authenticating its user using two-factor authentication. For example, in order to use the remote control device, a user inputs to the remote control device both the physical factor and the memorized factor. The remote control device then uses the input factors to authenticate the user using two-factor authentication. Upon authenticating the user, the remote control device enables one or more provided functions for use by the user. For example, the authenticated user may only be authorized to use the TV commands provided by the remote control device. In this instance, upon authenticating the user, the remote control device enables the TV controls and disables all other controls (e.g., VCR controls, DVD controls, computer system controls, etc.) that are provided on the remote control device. The remote control device may further limit the TV stations that are enabled depending on the identity of the user. In this manner, the remote control device is able to provide multiple user accounts that are accessed using two-factor authentication. Moreover, each user account may be provided access to varying degrees of functionality provided by the remote control device.

Although the subject matter has been described in language specific to structural features and/or methodological acts, it is to be understood that the subject matter defined in the appended claims is not necessarily limited to the specific features or acts described above. Though the remote control device has been described as controlling a computer system, it will be appreciated by those of ordinary skill in the art that other proxy devices or slave device that are capable of supporting two-factor authentication can be similarly be controlled. For example, the remote control device may be used to transmit representations of the physical and memorized factors to a set-top box that is configured to control audio, video, and electronic equipment. As another example, the remote control device and the supported two-factor authentication may be used to provide parental control. Accordingly, the specific features and acts described above are disclosed as example forms of implementing the claims.

I/We claim:

1. A method for providing two-factor authentication credentials using a remote control device, the method comprising:
upon detecting a need to provide two-factor authentication credentials to a system capable of receiving signals from a remote control device, at the remote control device, obtaining a physical factor;
obtaining a memorized factor; and
transmitting a signal representing the physical factor and the memorized factor,
wherein the transmitted signal is received by the system and used to authenticate the user using two-factor authentication.

2. The method of claim 1, wherein the physical factor is information contained on a smart card.

3. The method of claim 1, wherein the physical factor is information contained on a magnetic strip affixed to a card.

4. The method of claim 1, wherein the physical factor is a biometric characteristic.

5. The method of claim 4, wherein the biometric characteristic is a fingerprint.

6. The method of claim 4, wherein the biometric characteristic is a retina print.

7. The method of claim 4, wherein the biometric characteristic is a voice print.

8. The method of claim 1, wherein the signal is an infrared signal.

9. The method of claim 1, wherein the signal is a Bluetooth-compliant signal.

10. The method of claim 1, wherein the memorized factor is a PIN.

11. A remote control device comprising:
a physical factor reader operable to obtain a physical factor from a user;
a keypad operable to receive input from the user, wherein one of the inputs is a memorized factor;
a processor operable to process the physical factor and the memorized factor; and
a transmitter operable to transmit signals representing the physical factor and the memorized factor.

12. The device of claim 11, wherein the physical factor reader is a fingerprint reader.

13. The device of claim 11, wherein the physical factor reader is a retina reader.

14. The device of claim 11, wherein the physical factor reader is a smart card reader.

15. The device of claim 11, wherein the transmitter is an infrared transmitter.

16. The device of claim 11, wherein the transmitter is a Bluetooth-compliant transmitter.

17. The device of claim 11 further comprising a display screen operable to display the memorized factor.

18. The device of claim 11, wherein the memorized factor is a PIN.

19. A two-factor authentication-enabled remote control device comprising:
a keypad operable for receiving input commands from a user, wherein one of the input commands is a memorized factor;
a physical factor reader operable to obtain a physical factor from the user; and
logic capable of authenticating the user using the physical factor and memorized factor, the logic further capable of enabling functionality provided on the two-factor authentication-enabled remote control device upon authenticating the user.

20. The device of claim 19, wherein the enabled functionality varies depending on the user.
